(19) United States
(12) Patent Application Publication
(10) Pub. No.: US 2024/0190718 A1
(43) Pub. Date: Jun. 13, 2024

(54) MOLYBDENUM PRECURSORS AND RELATED METHODS

(71) Applicant: ENTEGRIS, INC., Billerica, MA (US)

(72) Inventors: Loren Press, Burnet, TX (US); Michael Watson, Leander, TX (US); Benjamin R. Garrett, Leander, TX (US); Bryan Clark Hendrix, Danbury, CT (US); Cristian Ocampo, Cedar Park, TX (US); Juan Valdez, Copperas Cove, TX (US); Robert L. Wright, JR., Newtown, CT (US)

(21) Appl. No.: 18/533,684

(22) Filed: Dec. 8, 2023

Related U.S. Application Data
(60) Provisional application No. 63/431,496, filed on Dec. 9, 2022.

(51) Int. Cl. C01G 39/04

(52) U.S. Cl. CPC C01G 39/04

(57) ABSTRACT

Molybdenum precursors with high purity and methods for purifying molybdenum precursors are provided. A method comprises obtaining a first vessel comprising a solid reagent; vaporizing at least a portion of the solid reagent to produce a vapor comprising a MoCl₅ vapor and a molybdenum impurity vapor; flowing at least a portion of the MoCl₅ vapor and at least a portion of the molybdenum impurity vapor to a second vessel; condensing at least a portion of the MoCl₅ vapor in the second vessel to separate the MoCl₅ from the molybdenum impurity; and removing at least a portion of the molybdenum impurity vapor from the second vessel to obtain a MoCl₅ precursor.

### FIELD

The present disclosure relates to molybdenum precursors and related methods, including, for example and without limitation, methods for purifying molybdenum precursors and methods for validating low impurity levels.

### PRIORITY

The present disclosure claims priority to U.S. Provisional Patent No. 63/431,496, with a filing date of Dec. 9, 2022, which is incorporated by reference herein for all purposes.

### BACKGROUND

The presence of impurities in precursors used for semiconductor fabrication results in defects and undesired process variability. Specifically, for solid precursors, separate crystals of an impurity can add impurity vapor into the vapor stream at levels much higher than dissolved impurities at the same impurity level. With the high sensitivity of the vapor content to impurity levels, current analytical techniques for measuring impurity level are not capable of detecting sufficiently low impurity levels.

### SUMMARY

Some embodiments relate to a method. In some embodiments, the method comprises one or more of the following steps: obtaining a first vessel comprising a solid reagent, the solid reagent comprising MoCl₅ and at least one of a molybdenum impurity, a non-molybdenum impurity, or any combination thereof; vaporizing at least a first portion of the solid reagent to produce a first vapor comprising a first molybdenum impurity vapor; removing at least a portion of the first molybdenum impurity vapor from the first vessel; vaporizing at least a second portion of the solid reagent to produce a second vapor comprising a second MoCl₅ vapor and a second molybdenum impurity vapor; flowing at least a portion of the second MoCl₅ vapor and at least a portion of the second molybdenum impurity vapor to a second vessel; condensing at least a portion of the second MoCl₅ vapor in the second vessel to separate the MoCl₅ from the second molybdenum impurity vapor; and removing at least a portion of the second molybdenum impurity vapor from the second vessel to obtain a MoCl₅ precursor.

Some embodiments relate to a method. In some embodiments, the method comprises one or more of the following steps: obtaining a precursor vessel comprising a MoCl₅ precursor and a headspace vapor; removing the headspace vapor from the precursor vessel; heating the precursor vessel to a target temperature; measuring a total pressure within the vessel to obtain a measured total pressure; comparing the measured total pressure to a reference value to validate or not validate a low impurity content of the MoCl₅ precursor, wherein, when the measured total pressure is within 1% to 10% of a true vapor pressure of the MoCl₅, the low impurity content is validated; wherein, when the measured total pressure is not within 1% to 10% of the true vapor pressure of the MoCl₅, the low impurity content is not validated.

Some embodiments relate to a method. In some embodiments, the method comprises one or more of the following steps: obtaining a precursor vessel comprising a MoCl₅ precursor and a headspace vapor; removing the headspace vapor from the precursor vessel; heating the precursor vessel to a target temperature; measuring a rate of change of total pressure within the vessel to obtain a measured rate of change of total pressure; comparing the measured rate of change of total pressure to a reference value to validate or not validate a low impurity content of the MoCl₅ precursor, wherein, when the rate of change of total pressure is greater than the reference value, the low impurity content of the precursor is not validated; wherein, when the rate of change of total pressure is equal to or less than the reference value, the low impurity content of the precursor is validated.

Some embodiments relate to a precursor vessel. In some embodiments, the precursor vessel comprises a MoCl₅ precursor. In some embodiments, the MoCl₅ precursor has, when the precursor vessel is maintained at a temperature of 340 K to 465 K, a measured vapor pressure of less than 1.3 times a calculated vapor pressure of the MoCl₅.

### BRIEF DESCRIPTION OF FIGURES

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIGS. 1A-1B are flowcharts of a method for purifying a molybdenum precursor, according to some embodiments.

FIGS. 2A-2B are flowcharts of a method for validating a low molybdenum impurity content of a molybdenum precursor, according to some embodiments.

FIG. 3 is a graphical view of a vapor pressure curve, according to some embodiments.

FIG. 4 is a graphical view of vapor pressure versus pumping time, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Some embodiments relate to a method for purifying a molybdenum precursor. Various embodiments of the method for purifying the molybdenum precursor are provided herein. It will be appreciated that any combination of steps, in any order, may be performed in the method for purifying the molybdenum precursor, without departing from the scope of this disclosure. Accordingly, that various methods and the steps of those methods are depicted in different figures shall not be limiting, as any combination of steps in any of the figures disclosed herein, in any combination, may be performed, without departing from the scope of this disclosure.

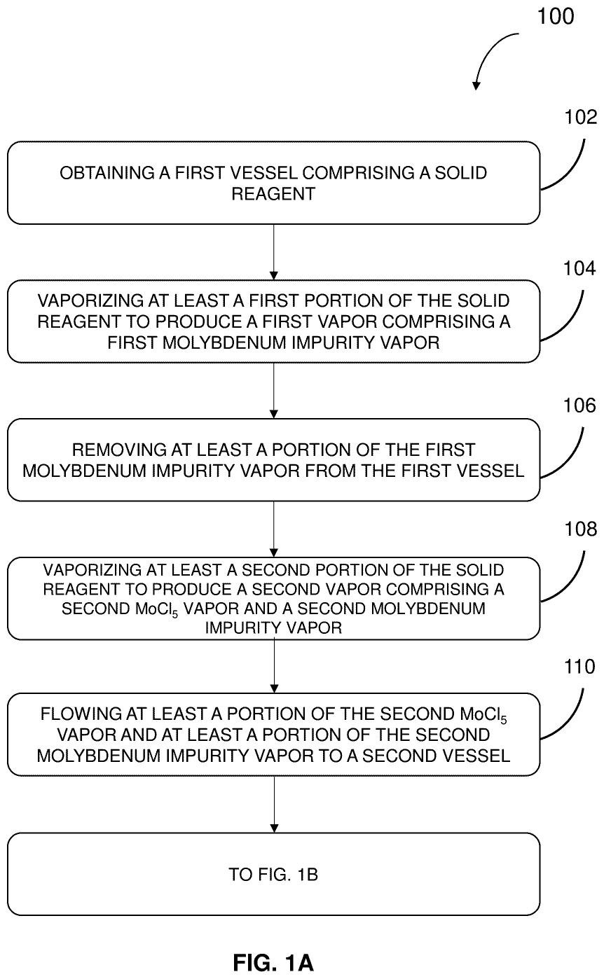

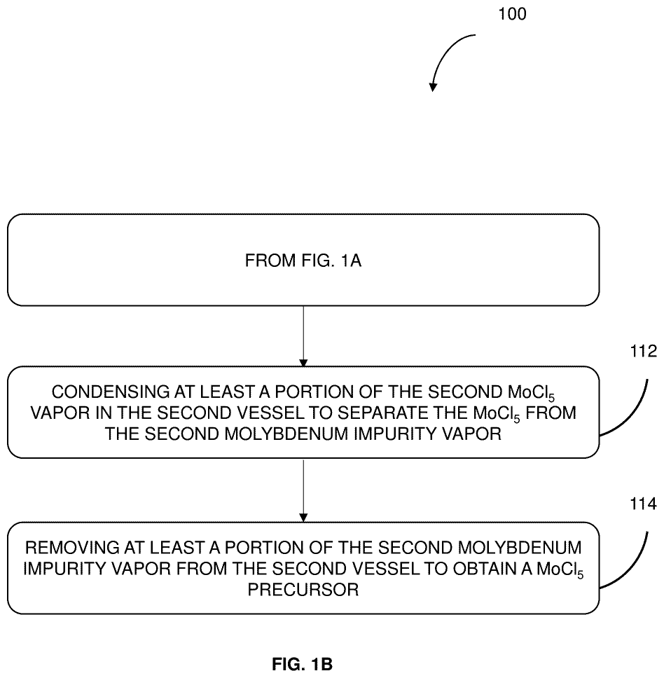

FIGS. 1A-1B are flowcharts of a method 100 for purifying a molybdenum precursor, according to some embodiments. As shown in FIGS. 1A-1B, the method 100 for purifying a molybdenum precursor may comprise one or more of the following steps: a step 102 of obtaining a first vessel comprising a solid reagent; a step 104 of vaporizing at least a first portion of the solid reagent to produce a first vapor comprising a first molybdenum impurity vapor; a step 106 of removing at least a portion of the first molybdenum impurity vapor from the first vessel; a step 108 of vaporizing at least a second portion of the solid reagent to produce a second vapor comprising a second MoCl₅ vapor and a second molybdenum impurity vapor; a step 110 of flowing at least a portion of the second MoCl₅ vapor and at least a portion of the second molybdenum impurity vapor to a second vessel; a step 112 of condensing at least a portion of the second MoCl₅ vapor in the second vessel to separate the MoCl₅ from the second molybdenum impurity vapor; and a step 114 of removing at least a portion of the second molybdenum impurity vapor from the second vessel to obtain a MoCl₅ precursor.

At step 102, in some embodiments, a first vessel may be obtained. In some embodiments, the first vessel comprises a solid reagent. In some embodiments, the first vessel comprises at least one of a molybdenum precursor, a molybdenum impurity, a non-molybdenum impurity, or any combination thereof. In some embodiments, the molybdenum precursor comprises molybdenum pentachloride (MoCl₅). In some embodiments, the molybdenum impurity comprises at least one of a molybdenum oxychloride, a molybdenum chloride (other than MoCl₅), a molybdenum oxide, or any combination thereof. In some embodiments, the molybdenum impurity comprises at least one of molybdenum tetrachloride (MoCl₄), molybdenum oxytetrachloride (MoOCl₄), molybdenum dioxydichloride (MoO₂Cl₂), molybdenum dioxydichloride (MoO₂Cl₂(H₂O)), molybdenum trioxide (MoO₃), or any combination thereof. In some embodiments, the molybdenum impurity comprises a non-volatile molybdenum impurity. In some embodiments, the non-volatile molybdenum impurity comprises at least one of molybdenum tetrachloride (MoCl₄), molybdenum trioxide (MoO₃), or any combination thereof. In some embodiments, the molybdenum impurity comprises a volatile molybdenum impurity. In some embodiments, the volatile molybdenum impurity comprises at least one of molybdenum oxytetrachloride (MoOCl₄), molybdenum dioxydichloride (MoO₂Cl₂), molybdenum dioxydichloride (MoO₂Cl₂(H₂O)), or any combination thereof. In some embodiments, the non-molybdenum impurity comprises a compound or molecule which does not comprise molybdenum. In some embodiments, the non-molybdenum impurity comprises at least one of HCl, hydrocarbons, metal-containing molecules, water, or any combination thereof.

The molybdenum precursor, the molybdenum impurity, and/or the non-molybdenum impurity may be independently present in the first vessel in a solid phase, a gas phase, a vapor phase, or any combination thereof. In some embodiments, the solid phase is amorphous or crystalline. For example, in some embodiments, the solid phase of the molybdenum precursor is amorphous or crystalline. In some embodiments, the solid phase of the molybdenum impurity is amorphous or crystalline. In some embodiments, the solid phase of the non-molybdenum impurity is amorphous or crystalline. In some embodiments, the solid phase is as an isolated crystal. For example, in some embodiments, the molybdenum precursor is present as an isolated crystal. In some embodiments, the molybdenum impurity is present as an isolated crystal. In some embodiments, the non-molybdenum impurity is present as an isolated crystal. In some embodiments, the solid phase is dissolved in a crystal lattice of another substance. For example, in some embodiments, the molybdenum impurity is present within the solid phase of the molybdenum precursor (MoCl₅). In some embodiments, the molybdenum impurity is dissolved in the crystal lattice of the MoCl₅. In some embodiments, the non-molybdenum impurity is present within the solid phase of the molybdenum precursor (MoCl₅). In some embodiments, the non-molybdenum impurity is dissolved in the crystal lattice of the MoCl₅.

The solid reagent may comprise at least one of a molybdenum precursor, a molybdenum impurity, or any combination thereof. In some embodiments, the solid reagent comprises 0.1% to 15% by weight of the molybdenum impurity based on a total weight of the solid reagent, or any range or subrange between 0.1% to 15%. In some embodiments, the solid reagent comprises 0.1% to 14%, 0.1% to 13%, 0.1% to 12%, 0.1% to 11%, 0.1% to 10%, 0.1% to 9%, 0.1% to 8%, 0.1% to 7%, 0.1% to 6%, 0.1% to 5%, 0.1% to 4%, 0.1% to 3%, 0.1% to 2%, 0.1% to 1%, or 0.1% to 0.5% by weight of the molybdenum impurity based on the total weight of the solid reagent. In some embodiments, the solid reagent comprises 0.5% to 15%, 1% to 15%, 2% to 15%, 3% to 15%, 4% to 15%, 5% to 15%, 6% to 15%, 7% to 15%, 8% to 15%, 9% to 15%, 10% to 15%, 11% to 15%, 12% to 15%, 13% to 15%, or 14% to 15% by weight of the molybdenum impurity based on the total weight of the solid reagent. In some embodiments, a remainder of the solid reagent comprises the molybdenum precursor. For example, in some embodiments, the solid reagent comprises to 40% to 99% of the molybdenum precursor based on the total weight of solid reagent.

The first vessel may be configured to control temperature. The temperature of the first vessel may be controlled in any suitable manner. In some embodiments, a thermal jacket for heating and/or cooling is employed around the first vessel. In some embodiments, a ribbon heater is wound around the first vessel. In some embodiments, a block heater having a shape covering at least a major portion of the external surface of the first vessel is employed to heat the first vessel. In some embodiments, a resistive heater is employed to heat the first vessel. In some embodiments, a lamp heater is employed to heat the first vessel. In some embodiments, a heat transfer fluid at elevated temperature may be contacted with the exterior surface of the first vessel, to effect heating and/or cooling thereof. In some embodiments, the heating is conducted by infrared or other radiant energy being impinged on the first vessel. In some embodiments, the second vessel is cooled by a fluid, a fan, a direct thermoelectric device, or any combination thereof. It is to be appreciated that other heating and/or cooling devices and assemblies, and other configurations and arrangements of the heater and/or cooler may be employed herein without departing from the scope of this disclosure.

The first vessel may be configured to control pressure. The pressure of the first vessel may be controlled in any suitable manner. In some embodiments, a gas inlet line is fluidly coupled to the first vessel. The gas inlet line may be configured to supply a pressurizing gas from a pressurizing gas source to the first vessel. Control of the pressurizing gas into the first vessel may be achieved by at least one of pressure regulators, needle valves, mass flow controllers, downstream pressure controllers, or any combination thereof. In some embodiments, the pressurizing gas comprises an inert gas. In some embodiments, the inert gas comprises at least one of helium, argon, nitrogen, or any combination thereof. In some embodiments, a vacuum line is fluidly coupled to the first vessel. The vacuum line may be configured to apply a vacuum to the first vessel. In some embodiments, the pumping speed is controlled by butterfly valves. It will be appreciated that other mechanisms for controlling the pressure of the first vessel may be employed herein without departing from the scope of this disclosure.

At step 104, in some embodiments, at least a first portion of the solid reagent and/or at least a first portion of the molybdenum impurity is vaporized in the first vessel. The vaporizing of the solid reagent and/or the molybdenum impurity may produce a first vapor comprising a first molybdenum impurity vapor. In some embodiments, the first vapor comprises a first molybdenum precursor vapor (e.g., a MoCl₅ vapor). In some embodiments, the vaporizing comprises applying a first condition (e.g., at least one of a temperature, a pressure, an inert gas flow, a vacuum, or any combination thereof) to the first vessel to produce the first molybdenum impurity vapor.

In some embodiments, the first condition is a condition under which a total pressure of the first vessel is below a true vapor pressure of the molybdenum impurity for a given first temperature. In some embodiments, the first condition is a condition under which a total pressure of the first vessel is above a true vapor pressure of the molybdenum precursor for a given first temperature. In some embodiments, the molybdenum impurity comprises the volatile molybdenum impurity. In some embodiments, the first condition is a condition such that the molybdenum impurity vaporizes, while minimizing the amount of the molybdenum precursor that is vaporized. In some embodiments, the first condition is a condition such that the molybdenum precursor is not vaporized. In some embodiments, the first condition is a condition such that isolated crystals of the molybdenum impurity are vaporized. In some embodiments, the first condition is a condition such that the molybdenum impurity, which is present in the crystal lattice of molybdenum precursor, is not vaporized or is not appreciably vaporized.

The first condition may comprise heating the first vessel at or to a first temperature. In some embodiments, the first temperature is a temperature in a range of 60° C. to 170° C., or any range or subrange between 60° C. to 170° C. In some embodiments, the first temperature is a temperature in a range of 60° ° C. to 160° C., 60° C. to 150° C., 60° ° C. to 140° C., 60° C. to 130° C., 60° C. to 120° C., 60° C. to 110° C., 60° ° C. to 100° C., 60° C. to 90° C., 60° C. to 80° C., 60° C. to 70° C., 70° C. to 170° C., 80° ° C. to 170° C., 90° ° C. to 170° C., 100° C. to 170° C., 110° C. to 170° C., 120° C. to 170° C., 130° ° C. to 170° C., 140° ° C. to 170° C., 150° C. to 170° C., 160° C. to 170° C., 100° ° C. to 160° C., 120° ° C. to 160° C., 140° ° C. to 160° C., 120° C. to 150° C., 120° C. to 140° C., or 110° C. to 150° C.

The first condition may comprise pressurizing (or depressurizing) the first vessel at or to a first pressure. In some embodiments, the first pressure is a pressure in a range of 0.01 Torr to 100 Torr, or any range or subrange therebetween. In some embodiments, the first pressure is a pressure in a range of 0.01 Torr to 95 Torr, 0.01 Torr to 90 Torr, 0.01 Torr to 85 Torr, 0.01 Torr to 80 Torr, 0.01 Torr to 75 Torr, 0.01 Torr to 70 Torr, 0.01 Torr to 65 Torr, 0.01 Torr to 60 Torr, 0.01 Torr to 55 Torr, 0.01 Torr to 50 Torr, 0.01 Torr to 45 Torr, 0.01 Torr to 40 Torr, 0.01 Torr to 35 Torr, 0.01 Torr to 30 Torr, 0.01 Torr to 25 Torr, 0.01 Torr to 20 Torr, 0.01 Torr to 15 Torr, 0.01 Torr to 10 Torr, 0.01 Torr to 5 Torr, 0.01 Torr to 1 Torr, 0.01 Torr to 0.1 Torr, 0.1 Torr to 100 Torr, 1 Torr to 100 Torr, 5 Torr to 100 Torr, 10 Torr to 100 Torr, 15 Torr to 100 Torr, 20 Torr to 100 Torr, 25 Torr to 100 Torr, 30 Torr to 100 Torr, 35 Torr to 100 Torr, 40 Torr to 100 Torr, 45 Torr to 100 Torr, 50 Torr to 100 Torr, 55 Torr to 100 Torr, 60 Torr to 100 Torr, 65 Torr to 100 Torr, 70 Torr to 100 Torr, 75 Torr to 100 Torr, 80 Torr to 100 Torr, 85 Torr to 100 Torr, 90 Torr to 100 Torr, or 95 Torr to 100 Torr.

The first vapor may comprise a greater volume of the molybdenum impurity (e.g., the first molybdenum impurity vapor) than the molybdenum precursor (e.g., the first molybdenum precursor vapor). In some embodiments, the first vapor comprises less than 10%, less than 9%, less than 8%, less than 7%, less than 6%, less than 5%, less than 4%, less than 3%, less than 2%, less than 1%, less than 0.1%, less than 0.01% by volume of the molybdenum precursor based on a total volume of the first vapor. In some embodiments, the first molybdenum impurity vapor comprises 0.01% to 10%, 0.01% to 9%, 0.01% to 8%, 0.01% to 7%, 0.01% to 6%, 0.01% to 5%, 0.01% to 4%, 0.01% to 3%, 0.01% to 2%, 0.01% to 1%, 0.01% to 0.1%, 0.1% to 10%, 1% to 10%, 2% to 10%, 3% to 10%, 4% to 10%, 5% to 10%, 6% to 10%, 7% to 10%, 8% to 10%, or 9% to 10% by volume of the molybdenum precursor based on the total volume of the first vapor.

At step 106, in some embodiments, at least a portion of the first molybdenum impurity vapor is removed from the first vessel. That is, in some embodiments, once vaporized, the first molybdenum impurity vapor may be removed from the first vessel to separate at least a first portion of the molybdenum impurity from the molybdenum precursor. The first molybdenum impurity vapor may be removed via an outlet of the first vessel. The outlet may be fluidly coupled to a gas discharge line, a vacuum line, or other similar line suitable for removing the first molybdenum impurity vapor from the first vessel.

At step 108, in some embodiments, at least a second portion of the solid reagent and/or at least a second portion of the molybdenum precursor is vaporized in a first vessel. The vaporizing of the molybdenum precursor and/or the solid reagent may produce a second vapor comprising a second molybdenum precursor vapor and a second molybdenum impurity vapor. In some embodiments, the vaporizing comprises applying a second condition (e.g., at least one of a temperature, a pressure, an inert gas flow, a vacuum, or any combination thereof) to the first vessel to produce the second molybdenum precursor vapor and/or the second molybdenum impurity vapor.

In some embodiments, the second condition is a condition under which a total pressure of the first vessel is below a true vapor pressure of the molybdenum precursor for a given second temperature. In some embodiments, the second condition is a condition under which a total pressure of the first vessel is above a true vapor pressure of non-volatile molybdenum impurities for a given second temperature. In some embodiments, the second condition is a condition such that the molybdenum precursor present in the first vessel as isolated crystals is vaporized. In some embodiments, the second condition is a condition such that the molybdenum precursor vaporizes, while minimizing the amount of non-volatile molybdenum impurities that is vaporized. In some embodiments, the second condition is a condition such that the non-volatile molybdenum impurities are not vaporized. In some embodiments, the second condition is a condition such that molybdenum impurities present in the crystal lattice of the molybdenum precursor are vaporized. In some embodiments, the second condition is a condition such that the molybdenum impurities present in the first vessel as isolated crystals are vaporized. In some embodiments, when applying the second condition, the second molybdenum precursor vapor comprises a greater volume of the molybdenum precursor, than the volatile molybdenum impurities and/or the non-volatile molybdenum impurities. In some embodiments, when applying the second condition, the second molybdenum precursor vapor comprises a greater volume of the volatile molybdenum impurities than the non-volatile molybdenum impurities.

The second condition may comprise heating the first vessel at or to a second temperature. In some embodiments, the second temperature is a temperature in a range of 60° C. to 170° C., or any range or subrange between 60° C. to 170° C. In some embodiments, the second temperature is a temperature in a range of 60° C. to 160° C., 60° C. to 150° C., 60° C. to 140° C., 60° C. to 130° C., 60° C. to 120° C., 60° C. to 110° C., 60° ° C. to 100° C., 60° ° C. to 90° C., 60° C. to 80° C., 60° C. to 70° C., 70° C. to 170° C., 80° ° C. to 170° C., 90° C. to 170° C., 100° C. to 170° C., 110° C. to 170° C., 120° ° C. to 170° C., 130° ° C. to 170° C., 140° ° C. to 170° C., 150° C. to 170° C., 160° C. to 170° C., 100° ° C. to 160° C., 120° C. to 160° C., 140° C. to 160° C., 120° C. to 150° C., 120° ° C. to 140° C., or 110° C. to 150° C. In some embodiments, the second temperature is greater than the first temperature. In some embodiments, the second temperature is less than the first temperature.

The second condition may comprise pressurizing (or depressurizing) the first vessel at or to a second pressure. In some embodiments, the second pressure is a pressure in a range of 0.01 Torr to 100 Torr, or any range or subrange therebetween. In some embodiments, the second pressure is a pressure in a range of 0.01 Torr to 95 Torr, 0.01 Torr to 90 Torr, 0.01 Torr to 85 Torr, 0.01 Torr to 80 Torr, 0.01 Torr to 75 Torr, 0.01 Torr to 70 Torr, 0.01 Torr to 65 Torr, 0.01 Torr to 60 Torr, 0.01 Torr to 55 Torr, 0.01 Torr to 50 Torr, 0.01 Torr to 45 Torr, 0.01 Torr to 40 Torr, 0.01 Torr to 35 Torr, 0.01 Torr to 30 Torr, 0.01 Torr to 25 Torr, 0.01 Torr to 20 Torr, 0.01 Torr to 15 Torr, 0.01 Torr to 10 Torr, 0.01 Torr to 5 Torr, 0.01 Torr to 1 Torr, 0.01 Torr to 0.1 Torr, 0.1 Torr to 100 Torr, 1 Torr to 100 Torr, 5 Torr to 100 Torr, 10 Torr to 100 Torr, 15 Torr to 100 Torr, 20 Torr to 100 Torr, 25 Torr to 100 Torr, 30 Torr to 100 Torr, 35 Torr to 100 Torr, 40 Torr to 100 Torr, 45 Torr to 100 Torr, 50 Torr to 100 Torr, 55 Torr to 100 Torr, 60 Torr to 100 Torr, 65 Torr to 100 Torr, 70 Torr to 100 Torr, 75 Torr to 100 Torr, 80 Torr to 100 Torr, 85 Torr to 100 Torr, 90 Torr to 100 Torr, or 95 Torr to 100 Torr. In some embodiments, the second pressure is less than a first pressure. In some embodiments, the second pressure is greater than a first pressure.

At step 110, in some embodiments, at least a portion of the second molybdenum precursor vapor and at least a portion of the second molybdenum impurity vapor are flowed to a second vessel. The vapors may be flowed from the first vessel via an outlet of the first vessel. The outlet may be fluidly coupled to a gas line or other similar line which is fluidly coupled to an inlet of the second vessel.

The second vessel may be configured to control temperature. The temperature of the second vessel may be controlled in any suitable manner. In some embodiments, a thermal jacket for heating and/or cooling is employed around the second vessel. In some embodiments, a ribbon heater is wound around the second vessel. In some embodiments, a block heater having a shape covering at least a major portion of the external surface of the second vessel is employed to heat the second vessel. In some embodiments, a resistive heater is employed to heat the second vessel. In some embodiments, a lamp heater is employed to heat the second vessel. In some embodiments, a heat transfer fluid at elevated temperature may be contacted with the exterior surface of the second vessel, to effect heating and/or cooling thereof. In some embodiments, the heating is conducted by infrared or other radiant energy being impinged on the second vessel. In some embodiments, the second vessel is cooled by a fluid, a fan, a direct thermoelectric device, or any combination thereof. It is to be appreciated that other heating and/or cooling devices and assemblies, and other configurations and arrangements of the heater and/or cooler may be employed herein without departing from the scope of this disclosure.

The second vessel may be configured to control pressure. The pressure of the second vessel may be controlled in any suitable manner. In some embodiments, a gas inlet line is fluidly coupled to the second vessel. The gas inlet line may be configured to supply a pressurizing gas from a pressurizing gas source to the second vessel. Control of the pressurizing gas into the second vessel may be achieved by at least one of pressure regulators, needle valves, mass flow controllers, downstream pressure controllers, or any combination thereof. In some embodiments, the pressurizing gas comprises an inert gas. In some embodiments, the inert gas comprises at least one of helium, argon, nitrogen, or any combination thereof. In some embodiments, a vacuum line is fluidly coupled to the second vessel. The vacuum line may be configured to apply a vacuum to the second vessel. In some embodiments, the pumping speed is controlled by butterfly valves. It will be appreciated that other mechanisms for controlling the pressure of the first vessel may be employed herein without departing from the scope of this disclosure.

At step 112, in some embodiments, at least a portion of the second molybdenum precursor vapor is condensed in the second vessel to separate the molybdenum precursor from the second molybdenum impurity vapor. In some embodiments, the condensing produces a molybdenum precursor condensate. In some embodiments, the condensing comprises applying a third condition (e.g., at least one of a temperature, a pressure, an inert gas flow, a vacuum, or any combination thereof) to the second vessel to produce the molybdenum precursor condensate.

The third condition may comprise heating the second vessel at or to a third temperature. In some embodiments, the third temperature is a temperature in a range of 10° C. to 100° C., or any range or subrange therebetween. In some embodiments, the third temperature is a temperature in a range of 20° C. to 100° C., 30° C. to 100° ° C., 40° C. to 100° C., 50° C. to 100° C., 60° C. to 100° C., 70° C. to 100° C., 80° C. to 100° C., 90° ° C. to 100° C., 10° C. to 90° C., 10° C. to 80° ° C., 10° C. to 70° C., 10° C. to 60° C., 10° C. to 50° C., 10° C. to 40° C., 10° C. to 30° C., or 10° C. to 20° C. In some embodiments, the third temperature is a temperature sufficient to cause the second molybdenum precursor vapor to condense, without condensing at least a portion of the second molybdenum impurity vapor.

The third condition may comprise pressurizing (or depressurizing) the second vessel at or to a third pressure. In some embodiments, the third pressure is a pressure in a range of 0.01 Torr to 100 Torr, or any range or subrange therebetween. In some embodiments, the third pressure is a pressure in a range of 0.01 Torr to 95 Torr, 0.01 Torr to 90 Torr, 0.01 Torr to 85 Torr, 0.01 Torr to 80 Torr, 0.01 Torr to 75 Torr, 0.01 Torr to 70 Torr, 0.01 Torr to 65 Torr, 0.01 Torr to 60 Torr, 0.01 Torr to 55 Torr, 0.01 Torr to 50 Torr, 0.01 Torr to 45 Torr, 0.01 Torr to 40 Torr, 0.01 Torr to 35 Torr, 0.01 Torr to 30 Torr, 0.01 Torr to 25 Torr, 0.01 Torr to 20 Torr, 0.01 Torr to 15 Torr, 0.01 Torr to 10 Torr, 0.01 Torr to 5 Torr, 0.01 Torr to 1 Torr, 0.01 Torr to 0.1 Torr, 0.1 Torr to 100 Torr, 1 Torr to 100 Torr, 5 Torr to 100 Torr, 10 Torr to 100 Torr, 15 Torr to 100 Torr, 20 Torr to 100 Torr, 25 Torr to 100 Torr, 30 Torr to 100 Torr, 35 Torr to 100 Torr, 40 Torr to 100 Torr, 45 Torr to 100 Torr, 50 Torr to 100 Torr, 55 Torr to 100 Torr, 60 Torr to 100 Torr, 65 Torr to 100 Torr, 70 Torr to 100 Torr, 75 Torr to 100 Torr, 80 Torr to 100 Torr, 85 Torr to 100 Torr, 90 Torr to 100 Torr, or 95 Torr to 100 Torr. In some embodiments, the third pressure is a pressure sufficient to cause the second molybdenum precursor vapor to condense, without condensing at least a portion of the second molybdenum impurity vapor.

In some embodiments, the third condition is applied to the second vessel, so as to produce the molybdenum precursor condensate, leaving the second molybdenum precursor vapor with a lesser amount of the second molybdenum precursor vapor. In some embodiments, the third condition is a condition sufficient to condense the second molybdenum precursor vapor, without condensing the second molybdenum impurity vapor or at least minimizing the volume of the second molybdenum impurity vapor that is condensed to separate the molybdenum precursor from the molybdenum impurity. In some embodiments, the third condition is a condition under which a greater volume of the second molybdenum precursor vapor condenses than the second molybdenum impurity vapor. In some embodiments, the molybdenum precursor condensate comprises a greater amount (e.g., mole fraction, volume, or mass fraction) of the molybdenum precursor, than molybdenum impurity (if any). In some embodiments, the third condition is a condition under which a greater volume of molybdenum impurity remains vaporized than the molybdenum precursor. In some embodiments, the third condition is a condition under which the second molybdenum impurity vapor comprises the molybdenum impurity which was dissolved in the crystal lattice of the molybdenum precursor (as well as, in some embodiments, isolated crystals of molybdenum oxychloride) and which was vaporized with the molybdenum precursor in the first vessel. a greater mole fraction of MoCl₅ than molybdenum oxychloride.

At step 114, in some embodiments, at least a portion of the second molybdenum impurity vapor is removed from the second vessel to obtain a purified precursor, such as a MoCl₅ precursor. That is, in some embodiments, once the molybdenum precursor is condensed, the second molybdenum impurity vapor may be removed from the second vessel to separate at least a portion of the molybdenum impurity from the molybdenum precursor. The second molybdenum impurity vapor may be removed via an outlet of the second vessel. The outlet may be fluidly coupled to a gas discharge line, a vacuum line, or other similar line suitable for removing the second molybdenum impurity vapor from the second vessel.

The purified precursor may recovered in the second vessel (or any other vessel). In some embodiments, the precursor comprises a MoCl₅ precursor. In some embodiments, the precursor comprises a MoCl₅ precursor having a low molybdenum impurity content. In some embodiments, the MoCl₅ precursor has, when the second vessel (or any other vessel) is maintained at a temperature of 340 K to 465 K, a vapor pressure of less than 1.3 times, less than 1.2 times, or less than 1.1 times a calculated vapor pressure of MoCl₅ determined according to the formula:

$$Log P ( Torr ) = 10.976 - \frac{4354}{T ( K )}$$

In some embodiments, the MoCl₅ maintains the vapor pressure for a duration up to 72 hours. In some embodiments, the MoCl₅ maintains the vapor pressure for a duration of 5 minutes to 72 hours.

In some embodiments, the MoCl₅ precursor has a low molybdenum impurity content. In some embodiments, the MoCl₅ precursor comprises 0.01% to 2% by weight of the molybdenum impurity based on a total weight of the MoCl₅ precursor, or any range or subrange between 0.01% to 2%. In some embodiments, the MoCl₅ precursor comprises 0.01% to 1.9%, 0.01% to 1.8%, 0.01% to 1.7%, 0.01% to 1.6%, 0.01% to 1.5%, 0.01% to 1.4%, 0.01% to 1.3%, 0.01% to 1.2%, 0.01% to 1.1%, 0.01% to 1%, 0.01% to 0.9%, 0.01% to 0.8%, 0.01% to 0.7%, 0.01% to 0.6%, 0.01% to 0.5%, 0.01% to 0.4%, 0.01% to 0.3%, 0.01% to 0.2%, 0.01% to 0.1%, or 0.01% to 0.05% by weight of the molybdenum impurity based on the total weight of the MoCl₅ precursor. In some embodiments, the MoCl₅ precursor comprises 0.05% to 1%, 0.1% to 1%, 0.2% to 1%, 0.3% to 1%, 0.4% to 1%, 0.5% to 1%, 0.6% to 1%, 0.7% to 1%, 0.8% to 1%, or 0.9% to 1% by weight of the molybdenum impurity based on the total weight of the MoCl₅ precursor.

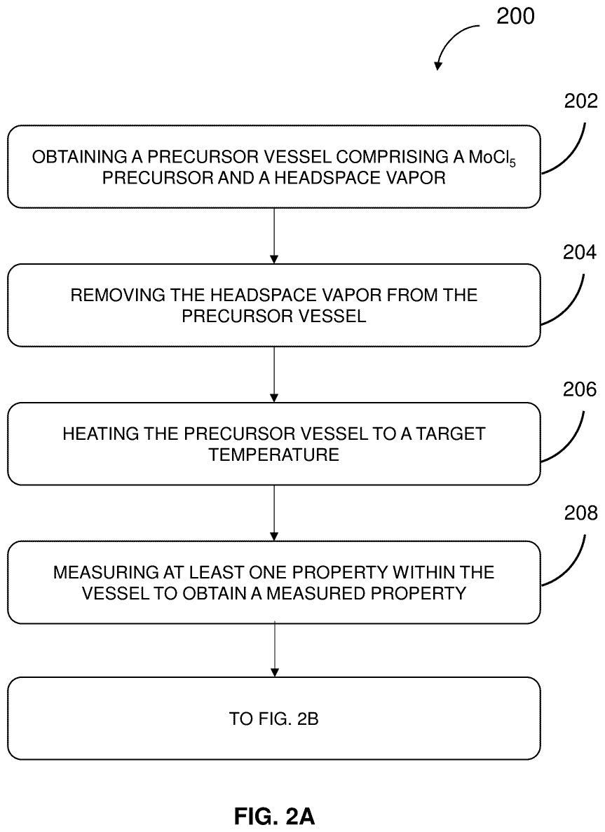

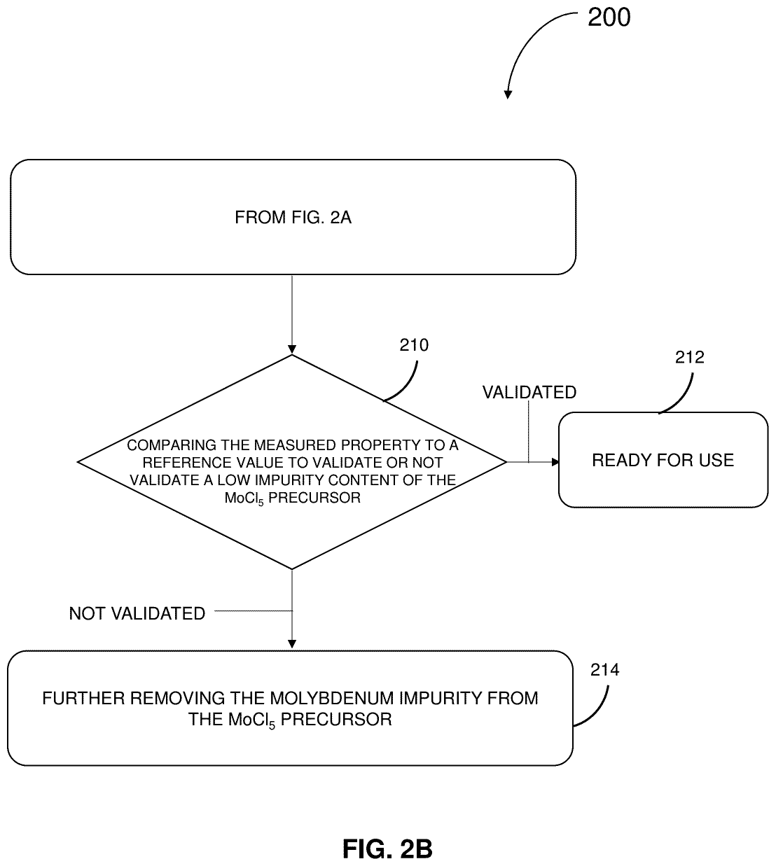

FIGS. 2A-2B are flowcharts of a method 200 for validating a low molybdenum impurity content of a molybdenum precursor, according to some embodiments. As shown in FIGS. 2A-2B, in some embodiments, the method 200 for validating a low molybdenum impurity content of a molybdenum precursor may comprise one or more of the following steps: a step 202 of obtaining a precursor vessel comprising a MoCl₅ precursor and a headspace vapor; a step 204 of removing the headspace vapor from the precursor vessel; a step 206 of heating the precursor vessel to a target temperature; a step 208 of measuring at least one property within the vessel to obtain a measured property; and a step 210 of comparing the measured property to a reference value to validate or not validate a low impurity content of the MoCl₅ precursor.

At step 202, a precursor vessel comprising a MoCl₅ precursor and a headspace vapor is obtained. The headspace vapor may comprise any vapor present in the headspace of the precursor vessel. In some embodiments, the headspace vapor comprises at least one of a molybdenum precursor, a molybdenum impurity, an inert, a nonmolybdenum vapor, or any combination thereof.

At step 204, the headspace vapor is removed from the precursor vessel. The headspace vapor may be removed from the precursor vessel via an outlet of the precursor vessel. The outlet may be fluidly coupled to a gas discharge line, a vacuum line, or other similar line suitable for removing the headspace vapor from the precursor vessel.

At step 206, the precursor vessel is heated at or to a target temperature. In some embodiments, the target temperature is a temperature in a range of 60° C. to 170° C., or any range or subrange between 60° C. to 170° C. In some embodiments, the target temperature is a temperature in a range of 60° C. to 160° C., 60° C. to 150° C., 60° ° C. to 140° C., 60° C. to 130° C., 60° C. to 120° C., 60° C. to 110° C., 60° C. to 100° C., 60° ° C. to 90° C., 60° ° C. to 80° C., 60° C. to 70° C., 70° C. to 170° C., 80° C. to 170° ° C., 90° C. to 170° C., 100° ° C. to 170° C., 110° C. to 170° C., 120° C. to 170° C., 130° ° C. to 170° C., 140° ° C. to 170° C., 150° C. to 170° C., 160° C. to 170° C., 100° C. to 160° C., 120° C. to 160° C., 140° ° C. to 160° C., 120° C. to 150° C., 120° C. to 140° C., or 110° C. to 150° C.

In some embodiments, the precursor vessel is pressurized (or depressurized) to a target pressure. In some embodiments, the target pressure is a pressure in a range of 0.01 Torr to 100 Torr, or any range or subrange therebetween. In some embodiments, the target pressure is a pressure in a range of 0.01 Torr to 95 Torr, 0.01 Torr to 90 Torr, 0.01 Torr to 85 Torr, 0.01 Torr to 80 Torr, 0.01 Torr to 75 Torr, 0.01 Torr to 70 Torr, 0.01 Torr to 65 Torr, 0.01 Torr to 60 Torr, 0.01 Torr to 55 Torr, 0.01 Torr to 50 Torr, 0.01 Torr to 45 Torr, 0.01 Torr to 40 Torr, 0.01 Torr to 35 Torr, 0.01 Torr to 30 Torr, 0.01 Torr to 25 Torr, 0.01 Torr to 20 Torr, 0.01 Torr to 15 Torr, 0.01 Torr to 10 Torr, 0.01 Torr to 5 Torr, 0.01 Torr to 1 Torr, 0.01 Torr to 0.1 Torr, 0.1 Torr to 100 Torr, 1 Torr to 100 Torr, 5 Torr to 100 Torr, 10 Torr to 100 Torr, 15 Torr to 100 Torr, 20 Torr to 100 Torr, 25 Torr to 100 Torr, 30 Torr to 100 Torr, 35 Torr to 100 Torr, 40 Torr to 100 Torr, 45 Torr to 100 Torr, 50 Torr to 100 Torr, 55 Torr to 100 Torr, 60 Torr to 100 Torr, 65 Torr to 100 Torr, 70 Torr to 100 Torr, 75 Torr to 100 Torr, 80 Torr to 100 Torr, 85 Torr to 100 Torr, 90 Torr to 100 Torr, or 95 Torr to 100 Torr.

At step 208, at least one property is measured within the precursor vessel to obtain a measured property. In some embodiments, the at least one property is at least one of a total pressure within the precursor vessel, the rate of change of total pressure within the precursor vessel, or any combination thereof. In some embodiments, the rate of change of total pressure is a rate of increase in pressure per unit time. For example, in some embodiments, the rate of change of total pressure is a rate of increase in pressure in Torr per minute. In some embodiments, the rate of change of total pressure is a rate of increase in pressure in millitorr per minute. In some embodiments, the rate of change of total pressure within the precursor vessel is measured for a duration between 30 seconds and 24 hours. It will be appreciated that the rate of change of total pressure may be in any suitable pressure units and time units. It will further be appreciated that the duration over which the rate of change of total pressure within the precursor vessel is measured may vary depending on the composition of the precursor (e.g., level of impurities) and the chosen target temperature and/or target pressure.

In some embodiments, the target temperature and/or the target pressure are selected such that a total pressure of the precursor vessel is within 10% of the true vapor pressure of the MoCl₅. In some embodiments, the target temperature and/or the target pressure are selected such that a total pressure of the precursor vessel is below a true vapor pressure of the molybdenum impurity. In some embodiments, the target temperature and the target pressure are selected to stabilize the precursor vessel at a reference temperature; an inlet gas flow to the precursor vessel is stopped; a short vacuum pump is applied to remove inert gas from the vapor phase in the precursor vessel; the precursor vessel is isolated from the vacuum pump; and then the pressure in the precursor vessel is monitored or measured over time.

At step 210, the measured property is compared to a reference value to validate or not validate a low impurity content of the MoCl₅ precursor. In some embodiments, when the low impurity content of the MoCl₅ precursor is validated, the MoCl₅ precursor is ready for use 212. In some embodiments, when the low impurity content of the MoCl₅ precursor is not validated, the method further comprises a step 214 of further removing the molybdenum impurity from the MoCl₅ precursor.

In some embodiments, the measured total pressure is compared to a reference value to validate or not validate a low impurity content of the MoCl₅ precursor. In some embodiments, when the total pressure is within 0.01% to 20%, or any range or subrange therebetween, of the reference value, the low molybdenum impurity content of the MoCl₅ precursor is validated. In some embodiments, when the total pressure is not within 0.01% to 20% of the reference value, the low molybdenum impurity content of the MoCl₅ precursor is not validated. In some embodiments, the reference value is the true vapor pressure of the MoCl₅ at conditions (e.g., a select temperature, a select pressure, or any combination thereof).

In some embodiments, the low molybdenum impurity content is validated if the measured total pressure is within 1% to 15%, 1% to 14%, 1% to 13%, 1% to 12%, 1% to 11%, 1% to 10%, 1% to 9%, 1% to 8%, 1% to 7%, 1% to 6%, 1% to 5%, 1% to 4%, 1% to 3%, 1% to 2%, 2% to 15%, 3% to 15%, 4% to 15%, 5% to 15%, 6% to 15%, 7% to 15%, 8% to 15%, 9% to 15%, 10% to 15%, 11% to 15%, 12% to 15%, 13% to 15%, 14% to 15%, 2% to 10%, 3% to 10%, 4% to 10%, 5% to 10%, 6% to 10%, 7% to 10%, 8% to 10%, or 9% to 10% of the true vapor pressure of the MoCl₅ at conditions. In some embodiments, when the measured total pressure is within 1% to 10% of a true vapor pressure of the MoCl₅, the low impurity content is validated. In some embodiments, when the measured total pressure is not within 1% to 10% of the true vapor pressure of the MoCl₅, the low impurity content is not validated. In some embodiments, when the low molybdenum impurity content is validated, the MoCl₅ precursor is ready for use.

In some embodiments, the rate of change of total pressure within the precursor vessel is compared to a reference value. In some embodiments, when the rate of change of total pressure is greater than the reference value, the low molybdenum impurity content of the precursor is not validated. In some embodiments, when the rate of change of total pressure is equal to or less than the reference value, the low molybdenum impurity content of the precursor is validated. For example, in some embodiments, when the rate of change of total pressure is 20% or less, 15% or less, 10% or less, 5% or less, 4% or less, 3% or less, 2% or less, or 1% or less per unit time, the low molybdenum impurity content of the MoCl₅ precursor is validated. In some embodiments, the reference value is 50 mT per min or less. For example, in some embodiments, the reference value is 45 mT per min or less, 40 mT per min or less, 35 mT per min or less, 30 mT per min or less, 25 mT per min or less, 20 mT per min or less, 15 mT per min or less, 10 mT per min or less, or 5 mT per min or less. It can be appreciated that for lower temperatures, the limiting value of pressure rise rate will be lower.

Some embodiments relate to a molybdenum precursor having sufficiently low impurity levels such that, when supplied to a tool used in semiconductor fabrication or other similar processes, the molybdenum precursor, upon being vaporized, is supplied to the tool at a controllable constant flow rate, without appreciable spikes or variations in flow rate. In some embodiments, a precursor vessel is provided. The precursor vessel may comprise a molybdenum precursor, such as, for example and without limitation, a MoCl₅ precursor having sufficiently low levels of molybdenum impurity. In some embodiments, the MoCl₅ precursor, when contained in the precursor vessel, has, when the precursor vessel is maintained at a temperature of 70° ° C. to 240° C. (or any range or subrange therebetween), a vapor pressure of less than 1.3 times, less than 1.2 times, or less than 1.1 times a calculated vapor pressure of MoCl₅ determined according to the formula:

$$Log P ( Torr ) = 10.976 - \frac{4354}{T ( K )} .$$

The MoCl₅ may maintain the vapor pressure for an indefinite duration. In some embodiments, the MoCl₅ maintains the vapor pressure for duration of up to 72 hours. In some embodiments, the MoCl₅ maintains the vapor pressure for a duration of 5 minutes to 72 hours, or any range or subrange therebetween.

### Aspects

Various Aspects are described below. It is to be understood that any one or more of the features recited in the following Aspect(s) can be combined with any one or more other Aspect(s).

Aspect 1. A method comprising:
obtaining a first vessel comprising a solid reagent, the solid reagent comprising MoCl₅ and at least one of a molybdenum impurity, a non-molybdenum impurity, or any combination thereof;
vaporizing at least a first portion of the solid reagent to produce a first vapor comprising a first molybdenum impurity vapor;
removing at least a portion of the first molybdenum impurity vapor from the first vessel;
vaporizing at least a second portion of the solid reagent to produce a second vapor comprising a second MoCl₅ vapor and a second molybdenum impurity vapor;
flowing at least a portion of the second MoCl₅ vapor and at least a portion of the second molybdenum impurity vapor to a second vessel;
condensing at least a portion of the second MoCl₅ vapor in the second vessel to separate the MoCl₅ from the second molybdenum impurity vapor;
and removing at least a portion of the second molybdenum impurity vapor from the second vessel to obtain a MoCl₅ precursor.

Aspect 2. The method of claim 1, wherein the molybdenum impurity comprises at least one of MoOCl₄, MoO₂Cl₂, MoO₂Cl₂(H₂O), MoO₃, or any combination thereof.

Aspect 3. The method of claim 2, wherein the solid reagent comprises 0.1% to 15% by weight of the MoOCl₄ based on a total weight of the solid reagent.

Aspect 4. The method of claim 2, wherein the solid reagent comprises 0.1% to 15% by weight of the MoO₂Cl₂ based on a total weight of the solid reagent.

Aspect 5. The method of claim 2, wherein the solid reagent comprises 0.1% to 15% by weight of the MoO₂Cl₂(H₂O) based on a total weight of the solid reagent.

Aspect 6. The method of claim 2, wherein the solid reagent comprises 0.1% to 15% by weight of the MoO₃ based on a total weight of the solid reagent.

Aspect 7. The method of claim 1, wherein the solid reagent comprises 0.1% to 5% by weight of the molybdenum impurity based on a total weight of the solid reagent.

Aspect 8. The method of claim 1, wherein the first vapor comprises a greater volume of the first molybdenum impurity vapor than the MoCl₅.

Aspect 9. The method of claim 1, wherein the second vapor comprises a greater volume of the second MoCl₅ vapor than the second molybdenum impurity vapor.

Aspect 10. The method of claim 1, wherein the MoCl₅ precursor comprises 0.01% to 1% by weight of the MoOCl₄ based on a total weight of the MoCl₅ precursor.

Aspect 11. The method of claim 1, wherein the MoCl₅ precursor comprises 0.01% to 1% by weight of the MoO₂Cl₂ based on a total weight of the MoCl₅ precursor.

Aspect 12. The method of claim 1, wherein the MoCl₅ precursor comprises 0.01% to 1% by weight of the MoO₂Cl₂(H₂O) based on a total weight of the MoCl₅ precursor.

Aspect 13. The method of claim 1, wherein the MoCl₅ precursor comprises 0.1% to 1% by weight of the MoO₃ based on a total weight of the MoCl₅ precursor.

Aspect 14. A method comprising:
obtaining a precursor vessel comprising a MoCl₅ precursor and a headspace vapor;
removing the headspace vapor from the precursor vessel;
heating the precursor vessel to a target temperature;
measuring a total pressure within the vessel to obtain a measured total pressure;
comparing the measured total pressure to a reference value to validate or not validate a low impurity content of the MoCl₅ precursor,
   wherein, when the measured total pressure is within 1% to 10% of a true vapor pressure of the MoCl₅, the low impurity content is validated;
   wherein, when the measured total pressure is not within 1% to 10% of the true vapor pressure of the MoCl₅, the low impurity content is not validated.

Aspect 15. The method of claim 14, further comprising, when the low impurity level is not validated, further removing the molybdenum impurity from the MoCl₅ precursor.

Aspect 16. A method comprising:
obtaining a precursor vessel comprising a MoCl₅ precursor and a headspace vapor;
removing the headspace vapor from the precursor vessel;
heating the precursor vessel to a target temperature;
measuring a rate of change of total pressure within the vessel to obtain a measured rate of change of total pressure;
comparing the measured rate of change of total pressure to a reference value to validate or not validate a low impurity content of the MoCl₅ precursor,
   wherein, when the rate of change of total pressure is greater than the reference value, the low impurity content of the precursor is not validated;
   wherein, when the rate of change of total pressure is equal to or less than the reference value, the low impurity content of the precursor is validated.

Aspect 17. The method of claim 16, wherein the reference value is a 5% change in total pressure per minute.

Aspect 18. The method of claim 16, further comprising, when the low impurity level is not validated, further removing the molybdenum impurity from the MoCl₅ precursor.

Aspect 19. An article comprising:
a precursor vessel comprising a MoCl₅ precursor,
   wherein the MoCl₅ precursor has, when the precursor vessel is maintained at a temperature of 340 K to 465 K, a measured vapor pressure of less than 1.3 times a calculated vapor pressure of the MoCl₅.

Aspect 20. The article of claim 1, wherein the calculated vapor pressure of the MoCl₅ is calculated according to the formula:

$$Log P ( Torr ) = 10.976 - \frac{4354}{T ( K )}$$

### Example 1

Material was loaded into an ampoule and sealed with valve under inert conditions. The ampoule was installed on a system that controls temperature, measures absolute pressure, and allows for pumping. The ampoule was heated to a temperature and stabilization for 30 minutes. The ampoule was pumped for a pre-determined pumping time. Then the pressure measurement manifold was isolated from the pump and the pressure was measured as a function of time for 5 minutes. The process may be repeated as many times as desired to achieve purity level desired.

### Example 2

Material was loaded into ampoule and sealed with valve under inert conditions. The ampoule was installed on a system that controls temperature, measures absolute pressure, and allows for pumping. The ampoule was pumped to remove inert gas and then heated to a desired temperature and stabilized for 30 minutes. The ampoule was pumped for 10 seconds. The ampoule was allowed to thermally re-equilibrate for 5 minutes while pumping the pressure measurement manifold. Then the pressure measurement manifold was isolated from the pump and opened to the ampoule for a pressure measurement. The pressure was measured as a function of time for 5 minutes. The material was validated because the initial pressure measurement was within 10% of the true vapor pressure of MoCl₅. Material may also be validated if the pressure rise rate is less than about 3%/minute.

### Example 3

Material was loaded into ampoule and sealed with valve under inert conditions. The ampoule was installed on a system that controls temperature, measures absolute pressure, and allows for pumping. The ampoule was pumped to remove inert gas and then heated to a desired temperature and stabilized for 30 minutes. The ampoule was pumped for 10 seconds. The ampoule was allowed to thermally re-equilibrate for 5 minutes while pumping the pressure measurement manifold. Then the pressure measurement manifold was isolated from the pump and opened to the ampoule for a pressure measurement. The pressure was measured as a function of time for 5 minutes. The material was validated because the pressure rise rate was less than 3%/minute.

### Example 4

An equation representing vapor pressures measured for molybdenum chloride and molybdenum oxychlorides is presented below:

$$Log P ( Torr ) = A + \frac{B}{T ( K )}$$

| Material | A | B |
|---|---|---|
| MoCl₅ | 10.976 | −4354 |
| MoOCl₄ | 10.418 | −3540 |
| MoO₂Cl₂ | 9.840 | −4270 |

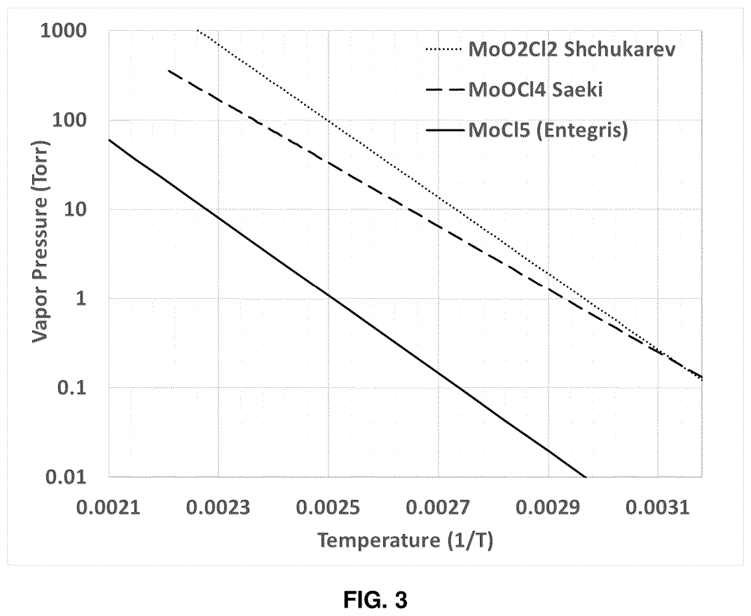

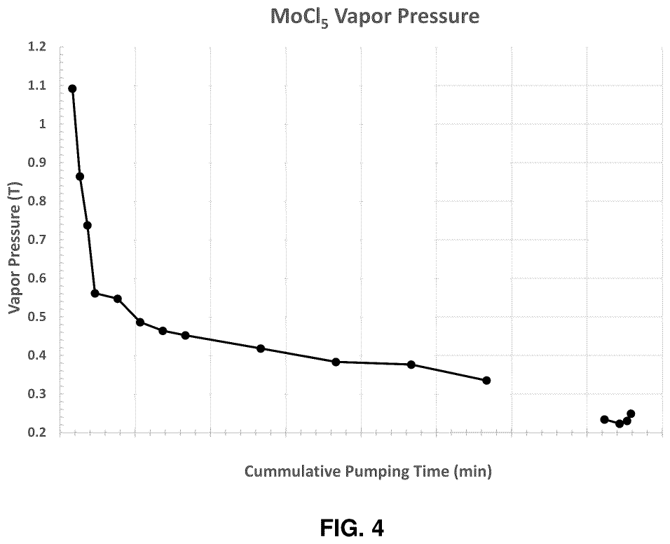

FIG. 3 is a graphical view of a vapor pressure curve, according to some embodiments. FIG. 4 is a graphical view of vapor pressure versus pumping time, according to some embodiments.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A method comprising:
obtaining a first vessel comprising a solid reagent, the solid reagent comprising MoCl₅ and at least one of a molybdenum impurity, a non-molybdenum impurity, or any combination thereof;
vaporizing at least a first portion of the solid reagent to produce a first vapor comprising a first molybdenum impurity vapor;
removing at least a portion of the first molybdenum impurity vapor from the first vessel;
vaporizing at least a second portion of the solid reagent to produce a second vapor comprising a second MoCl₅ vapor and a second molybdenum impurity vapor;
flowing at least a portion of the second MoCl₅ vapor and at least a portion of the second molybdenum impurity vapor to a second vessel;
condensing at least a portion of the second MoCl₅ vapor in the second vessel to separate the MoCl₅ from the second molybdenum impurity vapor; and
removing at least a portion of the second molybdenum impurity vapor from the second vessel to obtain a MoCl₅ precursor.

2. The method of claim 1, wherein the molybdenum impurity comprises at least one of MoOCl₄, MoO₂Cl₂, MoO₂Cl₂(H₂O), MoO₃, or any combination thereof.

3. The method of claim 2, wherein the solid reagent comprises 0.1% to 15% by weight of the MoOCl₄ based on a total weight of the solid reagent.

4. The method of claim 2, wherein the solid reagent comprises 0.1% to 15% by weight of the MoO₂Cl₂ based on a total weight of the solid reagent.

5. The method of claim 2, wherein the solid reagent comprises 0.1% to 15% by weight of the MoO₂Cl₂(H₂O) based on a total weight of the solid reagent.

6. The method of claim 2, wherein the solid reagent comprises 0.1% to 15% by weight of the MoO₃ based on a total weight of the solid reagent.

7. The method of claim 1, wherein the solid reagent comprises 0.1% to 5% by weight of the molybdenum impurity based on a total weight of the solid reagent.

8. The method of claim 1, wherein the first vapor comprises a greater volume of the first molybdenum impurity vapor than the MoCl₅.

9. The method of claim 1, wherein the second vapor comprises a greater volume of the second MoCl₅ vapor than the second molybdenum impurity vapor.

10. The method of claim 1, wherein the MoCl₅ precursor comprises 0.01% to 1% by weight of MoOCl₄ based on a total weight of the MoCl₅ precursor.

11. The method of claim 1, wherein the MoCl₅ precursor comprises 0.01% to 1% by weight of MoO₂Cl₂ based on a total weight of the MoCl₅ precursor.

12. The method of claim 1, wherein the MoCl₅ precursor comprises 0.01% to 1% by weight of MoO₂Cl₂(H₂O) based on a total weight of the MoCl₅ precursor.

13. The method of claim 1, wherein the MoCl₅ precursor comprises 0.1% to 1% by weight of MoO₃ based on a total weight of the MoCl₅ precursor.

14. A method comprising:
obtaining a precursor vessel comprising a MoCl₅ precursor and a headspace vapor;
removing the headspace vapor from the precursor vessel;
heating the precursor vessel to a target temperature;
measuring a total pressure within the precursor vessel to obtain a measured total pressure;
comparing the measured total pressure to a reference value to validate or not validate a low impurity content of the MoCl₅ precursor,
wherein, when the measured total pressure is within 1% to 10% of a true vapor pressure of MoCl₅, the low impurity content of the MoCl₅ precursor is validated;
wherein, when the measured total pressure is not within 1% to 10% of the true vapor pressure of MoCl₅, the low impurity content of the MoCl₅ precursor is not validated.

15. The method of claim 14, further comprising, when the low impurity content is not validated, removing a molybdenum impurity from the MoCl₅ precursor.

16. A method comprising:
obtaining a precursor vessel comprising a MoCl₅ precursor and a headspace vapor;
removing the headspace vapor from the precursor vessel;
heating the precursor vessel to a target temperature;
measuring a rate of change of total pressure within the precursor vessel to obtain a measured rate of change of total pressure;
comparing the measured rate of change of total pressure to a reference value to validate or not validate a low impurity content of the MoCl₅ precursor,
wherein, when the rate of change of total pressure is greater than the reference value, the low impurity content of the MoCl₅ precursor is not validated;
wherein, when the rate of change of total pressure is equal to or less than the reference value, the low impurity content of the MoCl₅ precursor is validated.

17. The method of claim 16, wherein the reference value is a 5% change in total pressure per minute.

18. The method of claim 16, further comprising, when the low impurity content is not validated, removing a molybdenum impurity from the MoCl₅ precursor.

19. An article comprising:
a precursor vessel comprising a MoCl₅ precursor,
wherein the MoCl₅ precursor has, when the precursor vessel is maintained at a temperature of 340 K to 465 K, a measured vapor pressure of less than 1.3 times a calculated vapor pressure of MoCl₅.

20. The article of claim 19, wherein the calculated vapor pressure of the MoCl₅ is calculated according to the formula:
$$Log P ( Torr ) = 10.976 - \frac{4354}{T ( K )} .$$
